(19) United States
(12) Patent Application Publication
(10) Pub. No.: US 2026/0268521 A1
(43) Pub. Date: Sep. 10, 2026

(54) METHODS, SYSTEMS, AND STORAGE MEDIUM FOR LOCATING MOBILE DEVICES

(71) Applicant: ZHEJIANG HUARAY TECHNOLOGY CO., LTD., Hangzhou (CN)

(72) Inventors: Kun HU, Hangzhou (CN); Peng SHI, Hangzhou (CN); Weiping HUANG, Hangzhou (CN); Bowen JI, Hangzhou (CN); Wei LU, Hangzhou (CN)

(73) Assignee: ZHEJIANG HUARAY TECHNOLOGY CO., LTD., Hangzhou (CN)

(21) Appl. No.: 19/663,516

(22) Filed: Apr. 30, 2026

Related U.S. Application Data
(63) Continuation of application No. PCT/CN2024/101184, filed on Jun. 25, 2024.

(30) Foreign Application Priority Data
Nov. 2, 2023 (CN) 202311458146.6

(51) Int. Cl. G06T 7/73; G06K 7/14; G06T 7/40

(52) U.S. Cl. CPC G06T 7/74; G06K 7/1417; G06K 7/1443; G06T 7/40; G06T 2207/30168

(57) ABSTRACT

A method, system, and storage medium for locating a mobile device, wherein the method is performed by a processing device comprising a memory and a processor, the method comprising obtaining a texture image acquired by a mobile device; determining a target texture template from a texture code library based on the texture image; determining a matched texture pair count based on the texture image and the target texture template; and in response to determining that the matched texture pair count is greater than a match threshold, determining a posture of the mobile device based on the matched texture pair count.

### CROSS REFERENCE TO RELATED APPLICATIONS

The present disclosure is a continuation of International Application No. PCT/CN2024/101184, filed on Jun. 25, 2024, which claims priority to Chinese patent application No. 202311458146.6, filed Nov. 2, 2023, the contents of which are incorporated herein in their entirety by reference.

### TECHNICAL FIELD

The present disclosure relates to the field of mobile robot navigation technology, and in particular, to a method, system, and storage medium for locating a mobile device.

### BACKGROUND

Technologies primarily used in the field of mobile robot navigation include laser navigation, visual navigation, and hybrid navigation manners that combine both. Among these, visual navigation technology typically relies on a camera mounted directly beneath the vehicle body to identify and locate QR codes. This approach offers good localization accuracy and stability compared to laser navigation. The QR code-based visual navigation scheme navigates and locates the mobile robot using a pre-established QR code topological map along with the recognition and decoding results of the QR codes. This process mainly involves image processing and binary coding (0-1) for pose estimation. However, when the QR code is partially obscured or contaminated, decoding failures or an inability to decode can easily occur, leading to localization failures for the mobile robot. Even if the code value is successfully decoded, the accuracy is often suboptimal, affecting the overall localization precision.

Accordingly, it is desired to provide a method, system, and storage medium for locating a mobile device to improve the robustness and localization accuracy of visual navigation.

### SUMMARY

One of the embodiments of the present disclosure provides a method for locating a mobile device. The method is performed by a processing device comprising a memory and a processor, the method comprising obtaining a texture image acquired by a mobile device. The method may comprise determining a target texture template from a texture code library based on the texture image. The method may comprise determining a matched texture pair count based on the texture image and the target texture template. The method may further comprise, in response to determining that the matched texture pair count is greater than a match threshold, determining a posture of the mobile device based on the matched texture pair count.

In some embodiments, the method may further comprise, in response to determining that the matched texture pair count is not greater than the match threshold, determining whether the matched texture pair count is greater than a pose threshold. The pose threshold may be less than the match threshold. The method may further comprise, in response to determining that the matched texture pair count is greater than the pose threshold, determining the posture of the mobile device based on the matched texture pair count.

In some embodiments, the method may further comprise, in response to determining that the matched texture pair count is greater than the pose threshold, generating a warning that the texture image is obscured or defaced.

In some embodiments, the method may further comprise, in response to determining that the matched texture pair count is not greater than the pose threshold, outputting a localization failure signal.

In some embodiments, the match threshold may be correlated with localization accuracy.

In some embodiments, the method may further comprise determining whether a preset image ID is obtained. The method may further comprise, in response to determining that the preset image ID is obtained, determining the target texture template from the texture code library based on the texture image and the preset image ID.

In some embodiments, the method may further comprise, in response to determining that the preset image ID is not obtained, determining the target texture template by searching the texture code library.

In some embodiments, the texture code library may be obtained by: determining a count of texture templates in the texture code library; obtaining a feature parameter of each texture feature point by randomly encoding each texture feature point of each texture template in the texture code library; assigning a template ID to the each texture template; and storing the template ID of the each texture template and the feature parameter of the each texture feature point in the texture code library.

In some embodiments, the feature parameter of the each texture feature point may include a radius and coordinates of the each texture feature point.

In some embodiments, the method may further comprise determining a radius of the each texture feature point of the each texture template based on a preset interval value and a random function. The method may further comprise determining coordinates of the each texture feature point of the each texture template based on a preset pixel dimension of the each texture template and the random function.

In some embodiments, the method may comprise determining the count of texture templates in the texture code library based on a preset pixel dimension of the each texture template, a preset count of texture feature points of the each texture template, and a preset pixel size of the each texture feature point.

In some embodiments, the method may comprise determining a count of combinations using a combination number formula based on the preset pixel dimension of each texture template, the preset count of texture feature points of each texture template, and the preset pixel size of each texture feature point. The method may further comprise determining the count of texture templates in the texture code library based on the count of combinations.

One of the embodiments of the present disclosure provides another method for locating a mobile device. The method is performed by a processing device comprising a memory and a processor, the method comprising determining a count of texture templates in a texture code library. The method may comprise obtaining a feature parameter of each texture feature point by randomly encoding each texture feature point of each texture template in the texture code library. The method may comprise assigning a template ID to the each texture template. The method may further comprise storing the template ID of the each texture template and the feature parameter of the each texture feature point in the texture code library.

One of the embodiments of the present disclosure provides a system for locating a mobile device, comprising a memory and a processor, the memory stores computer instructions, and when executing the computer instructions, the processor is directed to perform operations comprising: obtaining a texture image acquired by a mobile device; determining a target texture template from a texture code library based on the texture image; determining a matched texture pair count based on the texture image and the target texture template; in response to determining that the matched texture pair count is greater than a match threshold, determining a posture of the mobile device based on the matched texture pair count.

One of the embodiments of the present disclosure provides another system for locating a mobile device, comprising an obtaining module, a first determination module, a second determination module, and a third determination module. The obtaining module is configured to obtain a texture image acquired by a mobile device. The first determination module is configured to determine a target texture template from a texture code library based on the texture image. The second determination module is configured to determine a matched texture pair count based on the texture image and the target texture template. The third determination module is configured to determine, in response to determining that the matched texture pair count is greater than a match threshold, a posture of the mobile device based on the matched texture pair count.

One of the embodiments of the present disclosure provides a non-transitory readable medium. The storage medium stores computer instructions, when executed by at least one processor of an electrical device, the computer instructions direct the at least one processor to perform a method for locating a mobile device.

Additional features may be set forth in part in the description which follows, and in part may become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and where:

FIG. 1 is a schematic diagram illustrating an application scenario of a system for locating a mobile device according to some embodiments of the present disclosure;

FIG. 2 is a schematic diagram illustrating a system for locating a mobile device according to some embodiments of the present disclosure;

FIG. 3 is a flowchart illustrating a method for locating a mobile device according to some embodiments of the present disclosure;

FIG. 4 is a flowchart illustrating a method for locating a mobile device according to some embodiments of the present disclosure;

FIG. 5 is a flowchart illustrating a method for locating a mobile device according to some embodiments of the present disclosure;

FIG. 6A is a schematic diagram illustrating an exemplary structure of a QR code visual signpost according to some embodiments of the present disclosure;

FIG. 6B is a schematic diagram illustrating an exemplary structure of a QR code visual signpost according to some embodiments of the present disclosure;

FIG. 7 is a schematic diagram illustrating an exemplary texture template according to some embodiments of the present disclosure;

FIG. 8A is a schematic diagram illustrating an exemplary texture code according to some embodiments of the present disclosure; and

FIG. 8B is a schematic diagram illustrating an exemplary QR code according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present unless the context clearly indicates otherwise. As used herein, the term “and/or” includes any or all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

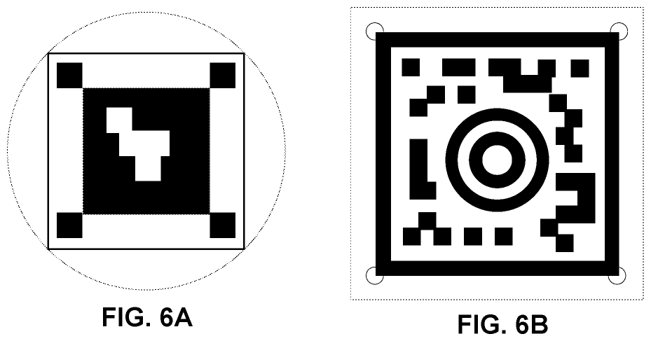

The QR code-based visual navigation scheme navigates and locates a mobile robot using a pre-established QR code topology map, coupled with the recognition and decoding results of QR codes. Currently, this approach involves a processing device that modifies standard QR codes by adding an outer circle, as shown in FIG. 6A, or an inner circle, as shown in FIG. 6B. These circles function as localization rings, aiding in the detection of the QR code by recognizing both the locating ring and the orienting frame (the outer frame of the QR code). Once the QR code is detected, the processing device decodes it to obtain the four corner points of the QR code, and subsequently performs homography solving to determine a relative posture of the mobile robot with respect to the QR code. This relative posture includes the position and orientation of the mobile robot within a specified coordinate system. The accuracy and stability of QR code decoding are critical for the process of determining this relative posture. When the localization ring or orientation frame of the QR code is partially obscured or contaminated, decoding failures can easily occur, resulting in the failure to locate the mobile robot. Even if the processing device successfully decodes the QR code, the accuracy may be compromised, affecting the homography matrix decomposition and ultimately the final localization accuracy.

Some embodiments of the present disclosure provide a method and system for locating a mobile device. The method includes obtaining a texture image acquired by a mobile device. The method includes determining a target texture template from a texture code library based on the texture image. The method includes determining a matched texture pair count based on the texture image and the target texture template. The method further includes, in response to determining that the matched texture pair count is greater than a match threshold, determining a posture of the mobile device based on the matched texture pair count.

According to embodiments of the present disclosure, the posture of the mobile device can be decoded based on the texture image and the texture template by matching texture feature point pairs, and the accuracy of the decoded posture is higher than that of the relative posture decoded based on the four corner points of the QR code, and the decoded posture can be realized even when the visible area of the texture code is small, thus improving the robustness of visual navigation.

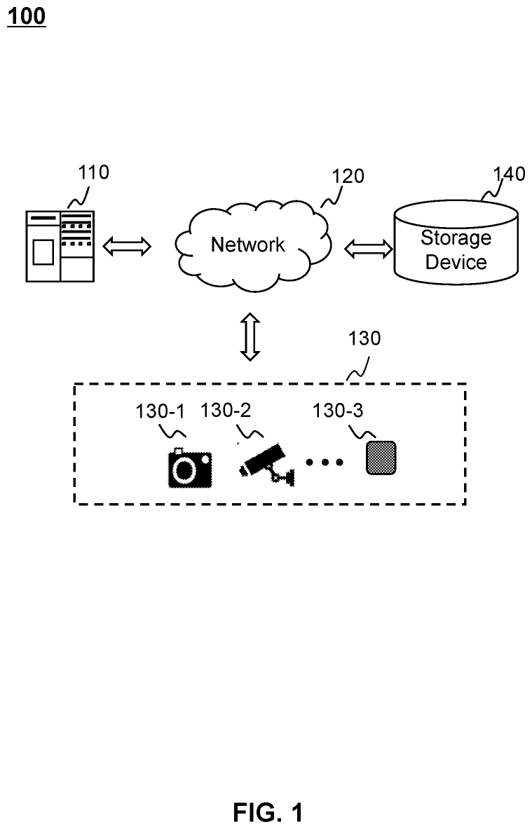

FIG. 1 is a schematic diagram illustrating an application scenario of a system for locating a mobile device according to some embodiments of the present disclosure. As shown in FIG. 1, in some embodiments, a system for locating a mobile device 100 may include a processing device 110, a network 120, an image acquisition device 130, and a storage device 140.

The processing device 110 may process information and/or data relating to the system for locating a mobile device 100 to perform one or more functions described in the present disclosure. For example, the processing device 110 may obtain a texture image acquired by a mobile device. The processing device 110 may determine a target texture template from a texture code library based on the texture image. The processing device 110 may determine a matched texture pair count based on the texture image and the target texture template. The processing device 110 may also, in response to determining that the matched texture pair count is greater than a match threshold, determine a posture of the mobile device based on the matched texture pair count. The processing device 110 may generate and obtain the texture code library.

The processing device 110 may be a single server or a server group. The server group may be centralized, or distributed (e.g., the processing device 110 may be a distributed system). In some embodiments, the processing device 110 may be local or remote. For example, the processing device 110 may access information and/or data stored in the image acquisition device 130 and/or the storage device 140 via the network 120. As another example, the processing device 110 may be directly connected to the image acquisition device 130 and/or the storage device 140 to access stored information and/or data. In some embodiments, the processing device 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the processing device 110 may include one or more processors (e.g., single-core processor(s) or multi-core processor(s)). Merely by way of example, the processing device 110 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may include any suitable network that can facilitate the exchange of information and/or data for the system for locating a mobile device 100. In some embodiments, one or more components (e.g., the processing device 110, the image acquisition device 130) of the system for locating a mobile device 100 may communicate information and/or data with one or more other components of the system for locating a mobile device 100 via the network 120. For example, the processing device 110 may obtain the texture image from the image acquisition device 130 via the network 120. In some embodiments, the network 120 may be or include a wired network, a wireless network (e.g., an 802.11 network, a Wi-Fi network), etc.

The image acquisition device 130 may be configured to acquire one or more images (the term “image” herein refers to a single image or a frame of a video). video). In some embodiments, the image acquisition device 130 may be a device or component on the mobile device that acquires an image (e.g., a mobile robot, etc.). In some embodiments, the image acquisition device 130 may include a camera 130-1, a video recorder 130-2, an image sensor 130-3, etc. The camera 130-1 may include a gun camera, a dome camera, an integrated camera, a monocular camera, a binocular camera, a multi-view camera, or the like, or any combination thereof. The video recorder 130-2 may include a PC Digital Video Recorder (DVR), an embedded DVR, or the like, or any combination thereof. The image sensor 130-3 may include a Charge Coupled Device (CCD) image sensor, a Complementary Metal Oxide Semiconductor (CMOS) image sensor, or the like, or any combination thereof. In some embodiments, the image acquisition device 130 may include a plurality of components each of which can acquire an image. For example, the image acquisition device 130 may include a plurality of sub-cameras that collect images or videos simultaneously. In some embodiments, the image acquisition device 130 may transmit an acquired image to one or more components (e.g., the processing device 110, the storage device 140) of the image system for locating a mobile device 100 via the network 120.

The storage device 140 may store data and/or instructions. The data and/or instructions may be obtained from, for example, the processing device 110, the image acquisition device 130, and/or any other component of the system for locating a mobile device 100. For example, the storage device 140 may store image data (e.g., the texture image) acquired by the image acquisition device 130 and/or a processing result (e.g., the texture code library, the posture of the mobile device, etc.) generated or determined by the processing device 110. In some embodiments, the storage device 140 may store data and/or instructions that the processing device 110 may execute or use to perform exemplary methods described in the present disclosure. In some embodiments, the storage device 140 may include a mass storage device, a removable storage device, a volatile read-and-write memory, a read-only memory (ROM), or the like, or any combination thereof. In some embodiments, the storage device 140 may be implemented on a cloud platform. In some embodiments, the storage device 140 may be part of the processing device 110 and/or the image acquisition device 130.

It should be noted that the above description is merely provided for the purposes of illustration, and is not intended to limit the scope of the present disclosure. For persons having ordinary skills in the art, multiple variations and modifications may be made under the teachings of the present disclosure. In some embodiments, the system for locating a mobile device 100 may include one or more additional components and/or one or more components of the system for locating a mobile device 100 described above may be omitted. For example, the system for locating a mobile device 100 may include one or more terminal devices. Additionally or alternatively, two or more components of the system for locating a mobile device 100 may be integrated into a single component. For example, the processing device 110 may be integrated into the image acquisition device 130. A component of the system for locating a mobile device 100 may be implemented on two or more sub-components. However, those variations and modifications do not depart from the scope of the present disclosure.

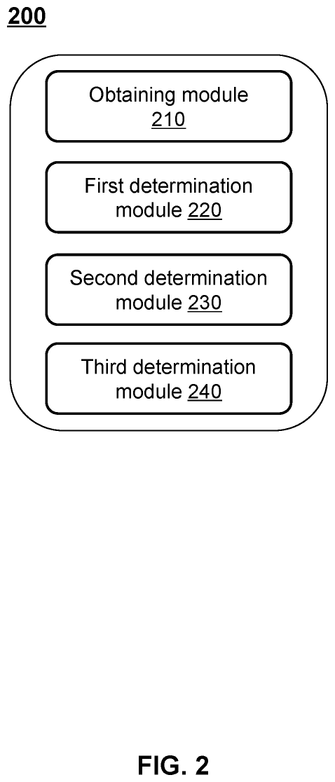

FIG. 2 is a schematic diagram illustrating a system for locating a mobile device according to some embodiments of the present disclosure. As shown in FIG. 2, a system for locating a mobile device 200 includes an obtaining module 210, a first determination module 220, a second determination module 230, and a third determination module 240. In some embodiments, the modules of the system for locating a mobile device 200 may be implemented by the processing device 110.

The obtaining module 210 may be configured to obtain a texture image collected by a mobile device. More descriptions of the obtaining the texture image collected by the mobile device may be found elsewhere in the present disclosure (e.g., a step 310 and the descriptions thereof).

The first determination module 220 may be configured to determine a target texture template from a texture code library based on the texture image. More descriptions of the determination of the target texture template may be found elsewhere in the present disclosure (e.g., a step 320 and the descriptions thereof).

The second determination module 230 may be configured to determine a matched texture pair count based on the texture image and the target texture template. More descriptions of the determination of the matched texture pair count may be found elsewhere in the present disclosure (e.g., a step 330 and the descriptions thereof).

The third determination module 240 may be configured to determine, in response to determining that the matched texture pair count is greater than a match threshold, a posture of the mobile device based on the matched texture pair count.

In some embodiments, the third determination module 240 may determine, in response to determining that the matched texture pair count is not greater than the match threshold, whether the matched texture pair count is greater than a pose threshold. The third determination module 240 may determine, in response to determining that the matched texture pair count is greater than the pose threshold, the posture of the mobile device based on the matched texture pair count. More descriptions of the determination of the posture of the mobile device may be found elsewhere in the present disclosure (e.g., steps 340-360 and the descriptions thereof).

In some embodiments, the system for locating a mobile device 200 may also include a generation module (not shown in the figures), which may be configured to generate the texture code library. More descriptions of the generation of the texture code library may be found elsewhere in the present disclosure (e.g., a process 500 and the descriptions thereof).

It should be noted that the above descriptions of the system for locating a mobile device 200 are provided for the purposes of illustration, and are not intended to limit the scope of the present disclosure. For persons having ordinary skills in the art, various modifications and changes in the forms and details of the application of the above system may occur without departing from the principles of the present disclosure. In some embodiments, the system for locating a mobile device 200 may include one or more other modules and/or one or more modules described above may be omitted. Additionally or alternatively, two or more modules may be integrated into a single module and/or a module may be divided into two or more units. However, those variations and modifications also fall within the scope of the present disclosure.

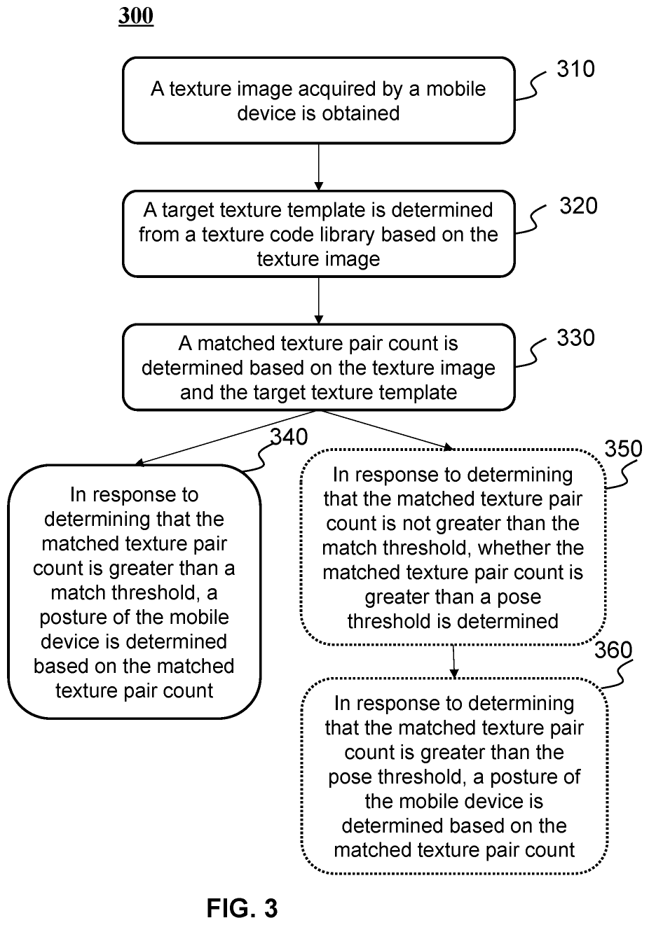

FIG. 3 is a flowchart illustrating a method for locating a mobile device according to some embodiments of the present disclosure. In some embodiments, a process 300 may be executed by the system for locating a mobile device 100 and/or the system for locating a mobile device 200. For example, the process 300 may be implemented as a set of instructions (e.g., an application) stored in a storage device (e.g., the storage device 140 illustrated in FIG. 1). In some embodiments, the processing device 110 of the system for locating a mobile device 100 and/or one or more modules of the system for locating a mobile device 200 may execute the set of instructions and may accordingly be directed to perform the process 300.

Step 310, a texture image acquired by a mobile device is obtained. In some embodiments, the step 310 may be performed by the obtaining module 210 shown in FIG. 2.

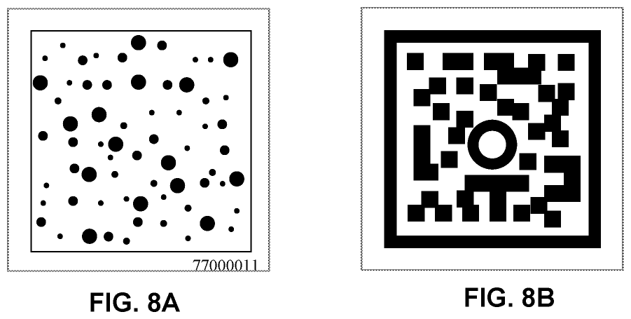

The texture image is an image that includes at least a portion of a texture code, and the texture code is graphical information capable of characterizing a location. In some embodiments, the texture code may include a plurality of texture feature points. Each texture feature point has a different feature parameter. The feature parameter includes a size, a position, an area, a shape, a color, a grayscale, a directionality, of the feature point, or any combination thereof. For example, the texture code may be as shown in FIG. 8A.

In some embodiments, the mobile device (e.g., a mobile robot, etc.) may carry an image acquisition device (e.g., the image acquisition device 130), and the mobile device may collect the texture image via the image acquisition device. For example, an automated sorting robot may collect an image of a texture code on the ground that it passed via an image sensor, thereby obtaining a texture image. The texture image may include a portion of a texture code or may include a complete texture code.

In some embodiments, the processing device 110 may acquire the texture image collected by the mobile device in various ways. For example, the processing device 110 may acquire the texture image directly from the mobile device. As another example, the processing device 10 may obtain the texture image from a storage device (e.g., the storage device 140).

Step 320, a target texture template is determined from a texture code library based on the texture image. In some embodiments, the step 320 may be performed by the first determination module 220 shown in FIG. 2.

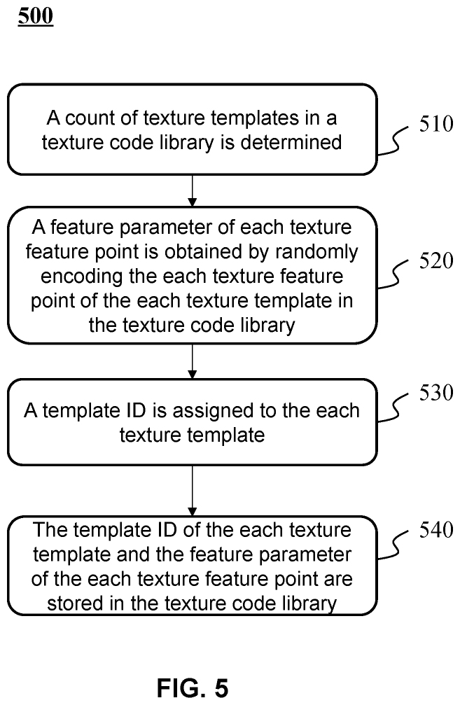

The texture template is a texture code that is used as a template, and the texture code library is a collection of a plurality of texture templates. Each texture template may have a template ID that identifies a unique texture template. In some embodiments, the texture code library may be pre-established and stored in a storage device (e.g., the storage device 140). A process for establishing the texture code library can be found in FIG. 5 and its related descriptions.

In some embodiments, when a known image ID is available during a navigation pre-loading process, a template ID that is the same as the known image ID may be identified from the texture code library based on the known image ID and the template ID, and a template that is the same as the known image ID may be determined as the target texture template. There is only one target texture template since the image ID is unique.

In some embodiments, when the known image ID is not available, the processing device 110 matches texture templates in the texture code library with the texture image one by one to determine the target texture template. The texture image may be matched with at least one texture template in the texture code library. When the texture image matches one or more texture templates in the texture code library, the texture image has at least one pair of matched texture feature points with the one or more texture templates. In this case, two matched texture feature points refer that the two texture feature points have the same feature parameters (e.g., positions of the two texture feature points are the same, sizes of the two texture feature points are the same, and shapes of the two texture feature points are the same). For example, in a case that a texture feature point X-1 in a texture code X matches a texture feature point A-1 in a texture template A, which means that the texture feature point X-1 and the texture feature point A-1 are of the same size and the same shape, and a location of the texture feature point X-1 in the texture code X and a location of the texture feature point A-1 in the texture template A are also the same. In the process of matching one by one, the target texture template may include one or more. For more details on the determination of the target texture template, please refer to a process 400 below.

Step 330, a matched texture pair count is determined based on the texture image and the target texture template. In some embodiments, the step 330 may be performed by the second determination module 230 shown in FIG. 2.

In some embodiments, the processing device 110 may match the texture image with texture feature points in the target texture template to determine the matched texture pair count. Specifically, the processing device 110 may retrieve a target texture template from the texture code library and match the texture image with the target texture template. First, the processing device 110 may decompose the texture image into a plurality of region images based on a preset image decomposition algorithm (e.g., a quadtree structure algorithm, etc.). The processing device 110 may extract texture feature points in each region image to obtain detection texture feature points by a preset image feature extraction algorithm (e.g., a fast feature point detection approach, etc.). The processing device 110 may use a preset algorithm (e.g., an rBRIEF algorithm, etc.) to select n (n>1) pixel points within a set range centered on the detection texture feature points to form n feature point pairs with the detection texture feature points, and generate combinations of codes with a code value of 0 or 1 by comparing grayscale values and assigning a binary value of 0 or 1 for the each feature point pair according to a comparison result. The processing device 110 may perform a weighted summation of the combinations of codes to determine a mass center of the n feature point pairs. The processing device 110 may connect the detection texture feature points to the mass center and determine an orientation angle of the detection texture feature points. The processing device 110 may rotate pixel points in each region image according to the orientation angle to sample the pixel points and obtain feature point pairs in the region image in a rotated state. The processing device 110 may further compare a feature point of each feature point pair in the rotated region image with corresponding feature point pair of corresponding feature point pair in the target texture template to determine whether the two feature point are matched texture pair, thereby determining the matched texture pair count of the texture image and the target texture template.

In some embodiments, when the target texture template includes a plurality of target texture templates, the processing device 110 may perform the method described above on each of the target texture templates to determine a matched texture pair count corresponding to the each target texture template. The processing device 110 may sort all matched texture pair counts corresponding to the each target texture template in descending order, and a target texture template with a highest matched texture pair count is determined as a final target texture template for subsequent determination of a posture of the mobile device.

In some embodiments, the processing device 110 may determine whether the matched texture pair count is greater than a match threshold. In response to determining that the matched texture pair count is greater than the match threshold, the processing device 110 may determine the posture of the mobile device by performing a step 340.

Step 340, in response to determining that the matched texture pair count is greater than the match threshold, the posture of the mobile device is determined based on the matched texture pair count. In some embodiments, the step 340 may be performed by the third determination module 240 shown in FIG. 2.

The posture of the mobile device is a location and orientation of the mobile device relative to a reference coordinate system. For example, a posture of the mobile robot may be a latitude and a longitude of the mobile robot or a coordinate value of the mobile robot in a preset 2D or 3D coordinate system, etc. In some embodiments, if the matched texture pair count is greater than the match threshold, it indicates that the mobile device is currently in a correct location. For example, the mobile device does not deviate from a location of the texture image. The locating of the mobile device is successful, the processing device 110 may calculate location information through a single responsiveness algorithm based on the matched texture pair count, thereby determining the posture of the mobile device. The processing device 110 may determine the posture of the mobile device based on the matched texture pair count using any approach, which is not limited by the present disclosure. For example, the processing device 110 may determine the posture of the mobile device according to an approach disclosed in Chinese application No. CN 113029160 A.

In some embodiments, the match threshold may be correlated with localization accuracy. The localization accuracy refers to an accuracy required for locating a mobile device. The greater the localization accuracy, the greater the match threshold, which means that the greater the required localization accuracy for the mobile device, the more matched texture pair counts are required. The accuracy of the pose estimation is improved by setting the match threshold, which ensures and improves the localization accuracy. In some embodiments, the match threshold may be set artificially based on experience and stored in a storage device (e.g., the storage device 140). In some embodiments, the match threshold may be set by different application scenarios. For example, a match threshold for an application scenario requiring high localization accuracy (e.g., industrial processing, assembly, etc.) is greater than a match threshold for an application scenario requiring low localization accuracy (e.g., distribution, etc.). In some embodiments, the match threshold is adjustable. For example, the match threshold may be modified based on feedback from a localization result. By adjusting the match threshold, texture codes of different qualities (e.g., different degrees of defacement) may be well adapted. As another example, by utilizing augmented reality technology, a decoding process may be combined with an actual scenario to provide real-time feedback on a decoding result to further adjust the match threshold, thereby adjusting the localization accuracy. In some embodiments, using deep learning technology to determine the match threshold by training a deep learning model can improve the adaptability and generalization ability of decoding, and can easily cope with texture codes of different qualities and types.

In some embodiments, in response to determining that the matched texture pair count is not greater than the match threshold, the processing device 110 may determine the posture of the mobile device by performing steps 350-360.

Step 350, in response to determining that the matched texture pair count is not greater than the match threshold, whether the matched texture pair count is greater than a pose threshold is determined. In some embodiments, the step 350 may be performed by the third determination module 240 shown in FIG. 2.

In some embodiments, in response to determining that the matched texture pair count is not greater than the match threshold, the processing device 110 may determine whether the matched texture pair count is greater than the pose threshold. The pose threshold is less than the match threshold. The reliability of the pose estimation is ensured by setting the pose threshold, and the success rate of the pose estimation is improved.

The pose threshold is used to characterize uniqueness of a texture image. In some embodiments, the pose threshold may be set based on accuracy (e.g., an image resolution) of a texture image to be recognized, which ensures uniqueness of image recognition. The greater the accuracy of the image, the greater the pose threshold. For example, if 4 coplanar and non-collinear points determine the uniqueness of the texture image, then the pose threshold may be 4. As another example, if 6 coplanar and non-collinear points determine the uniqueness of the texture image, then the pose threshold may be 6. In some embodiments, the pose threshold may be set artificially based on experience and stored in a storage device (e.g., the storage device 140). In some embodiments, the pose threshold is adjustable. For example, the pose threshold may be modified based on a feedback of a localization result, and by adjusting the pose threshold, the texture codes of different qualities (e.g., different degrees of defacement) can be well adapted. As another example, by utilizing augmented reality technology, the decoding process may be combined with an actual scenario to provide real-time feedback on the decoding result to further adjust the pose threshold, thereby adjusting the localization accuracy. In some embodiments, using deep learning technology to determine the pose threshold by training a deep learning model can improve the adaptability and generalization ability of decoding, and can easily cope with texture codes of different qualities and types.

Step 360, in response to determining that the matched texture pair count is greater than the pose threshold, the posture of the mobile device is determined based on the matched texture pair count. In some embodiments, the step 360 may be performed by the third determination module 240 shown in FIG. 2.

In response to determining that the matched texture pair count is not greater than the match threshold and is greater than the pose threshold, it means that the matched texture pair count still satisfies a pose estimation requirement. In some embodiments, in response to determining that the matched texture pair count is greater than the pose threshold, the processing device 110 may determine the posture of the mobile device based on the matched texture pair count in the same manner as the determination of the position of the mobile device in the step 330. By setting the pose threshold, it can avoid a decoding failure when the matched texture pair count is not greater than the match threshold. The decoding process can still be executed when the localization accuracy is not satisfied, and at the same time, a corresponding warning may be uploaded, thereby improving the robustness of localization.

When recognition information (e.g., a QR code, a texture code, etc.) in an image is defaced or obscured, this results in a reduction of effective recognition information. Usually, when the QR code is defaced or obscured for the most part, for decoding the QR code, a visible area of the QR code needs to be larger than 75% of an overall image of the QR code. While, for the texture code, when the texture code is defaced or obscured for the most part, and a visible area of the texture code is larger than a proportion threshold (e.g., 30%) of an overall image of the texture code, a method for locating a mobile device according to the embodiments of the present disclosure still achieves an accurate localization. For situations where the localization fails or the accuracy is insufficient due to a reduction in effective image recognition information, the method according to the embodiments of the present disclosure provides stronger robustness.

If the determined matched texture pair count is not greater than the match threshold and is greater than the pose threshold, which indicates that the texture code in the texture image may be defaced or be partially obscured. When the matched texture pair count n_{match} is greater than the pose threshold thredₚₒₛₑ, a match may theoretically be considered successful. However, considering the accuracy of the pose estimation, a match threshold thredₚₒₛₑ which is greater than the pose threshold thredₚₒₛₑ may be set, and when the matched texture pair count n_{match}>the match threshold thred_{match}, a relative posture of the mobile device determined based on the matched texture pair count n_{match} is accurate. When the pose threshold thredₚₒₛₑ<the matched texture pair count n_{match}<the match threshold thred_{match}, the match may be considered successful theoretically, but in practice, a match result is poor due to obscure or defacement of the texture code, so a warning that the texture code is obscured or defaced may also be reported. In some embodiments, in response to determining that the matched texture pair count is greater than the pose threshold, the processing device 110 may generate a warning that the texture image is obscured or defaced. For example, the processing device 110 may prompt a user that “a complete texture image is not recognized, and the texture image may be obscured or defaced.”

If the determined matched texture pair count is not greater than the pose threshold, it means that the matched texture pair count does not satisfy a pose estimation requirement. In some embodiments, in response to determining that the matched texture pair count is not greater than the pose threshold, the processing device may output a localization failure signal. For example, the processing device 110 may prompt the user that “the texture image could not be recognized, the localization is failed.”

In some embodiments of the present disclosure, the posture of the mobile device is determined by determining whether the texture code in the texture image matches a preset texture template based on a result of comparing each of the two preset thresholds (e.g., the match threshold and the pose threshold (the pose threshold is smaller than the match threshold)) with the matched texture pair count, respectively. The accuracy of pose estimation can be improved by setting a greater match threshold. When the matched texture pair count reaches the pose threshold, it can be regarded as a successful match and a relative posture can be solved, but when the matched texture pair count reaches the match threshold, the more the matched texture pair counts, the greater the accuracy of the relative posture. The match threshold and the pose threshold may be configured to satisfy scenarios of recognizing texture codes of different accuracy.

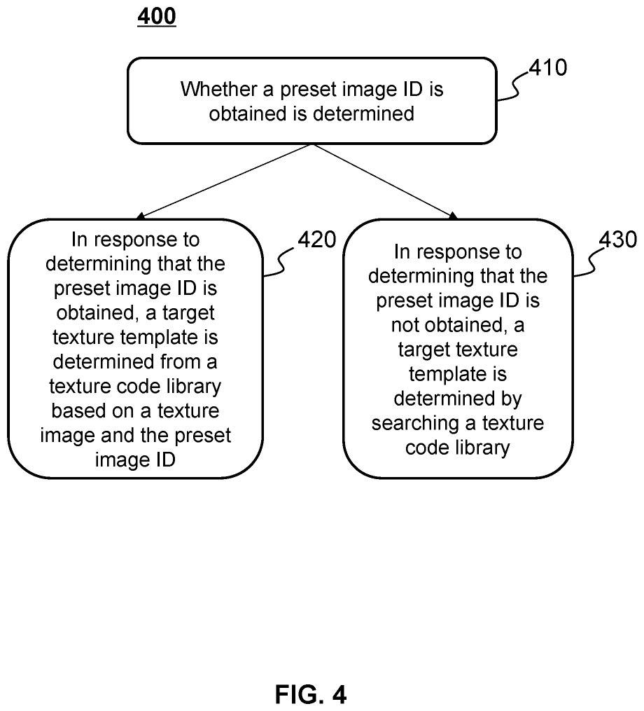

FIG. 4 is a flowchart illustrating a method for locating a mobile device according to some embodiments of the present disclosure. In some embodiments, at least part of a process 400 may be performed to achieve at least part of the step 320 as described in connection with FIG. 3. For example, the processing device 110 or the first determination module 220 may determine a target texture template from a texture code library by performing at least part of the process 400.

Step 410, whether a preset image ID is obtained is determined.

An image ID is information that uniquely identifies an image. For example, the image ID may include a code consisting of numbers, letters, or characters, etc. Typically, due to the preloading feature of map path nodes of the navigation scheme, a mobile device may know an identification (ID) of a texture image it is about to pass in real-time during a normal navigation and localization process. In some embodiments, after acquiring a texture image, the processing device 110 may determine whether a preset image ID is obtained. The preset image ID uniquely identifies the texture image.

Step 420, in response to determining that the preset image ID is obtained, the target texture template is determined from the texture code library based on the texture image and the preset image ID.

In some embodiments, if the preset image ID is obtained, since each texture template in the texture code library has a unique ID, the processing device 110 may search the texture code library based on the image ID to identify a texture template whose ID matches with the image ID, and designate the texture template as a target texture template. A texture template ID matches with an image ID refers that the texture template ID and the image ID are the same or the texture template ID and the image ID have a correspondence, etc. The correspondence between two IDs may include that one preset image ID corresponds to one or more texture template IDs. Thus, the target texture template may include one or more target texture templates. By directly using the preset image ID to match the texture template ID, a required match time is short, which enables a fast determination of the target texture template.

Step 430, in response to determining that the preset image ID is not obtained, the target texture template is determined by searching the texture code library.

In some embodiments, if the preset image ID is not obtained, the processing device 110 may match the texture image with texture templates in the texture code library one by one, and designate a texture template that matches the texture image as the target texture template. A process for matching the texture image with texture templates may be similar to that described in the step 330, and a condition for determining whether the texture image matches with a texture template may include the matched texture pair count determined based on the texture image and the target texture template is greater than a preset threshold, and the preset threshold is less than or equal to the pose threshold. When it is not possible to obtain the preset image ID, although obtaining the target texture template by matching one by one takes a long matching time, the matching accuracy is ensured.

In some embodiments, the search and matching steps in the step 420 and the step 430 may be performed using parallel operations such as multithreading. For example, the processing device 110 may perform operations in the step 420 and the step 430 through a processor or multi-core processor that supports multi-threading. This can speed up the matching process and improve processing efficiency.

FIG. 5 is a flowchart illustrating an exemplary method for locating a mobile device according to some embodiments of the present disclosure. In some embodiments, at least part of a process 500 may be performed to generate a texture code library as described in connection with FIG. 3. For example, the processing device 110 or a generation module may generate the texture code library by performing at least part of the process 500. In some embodiments, the process 500 may be performed prior to the step 310, and a texture code in a texture image may be generated based on a texture template in the texture code library.

Step 510, a count of texture templates in a texture code library is determined.

The texture code library is a database that stores texture templates and information of the texture templates. The information of a texture template includes an identification (e.g., ID) of the texture template, a feature parameter of each texture feature point of the texture template (e.g., a radius of each texture feature point, coordinates of a center point of the each texture feature point, a grayscale of the each feature point, a directional feature of the each feature point, a color of the each feature point, a shape of the each feature point, a size of the each feature point, etc.).

In some embodiments, the processing device 110 may determine a count of texture templates in the texture code library based on a preset pixel dimension of each texture template, a preset count of texture feature points in the each texture template, and a preset pixel size of each texture feature point. The count is denoted as Num, with Num being a positive integer. The preset pixel size of the each texture feature point is a size of a pixel grid occupied by the each texture feature point (the size of the pixel grid is a count of pixel points in the pixel grid). The preset pixel dimension of the each texture template, the preset count of texture feature points in the each texture template, and the preset pixel size of the each texture feature point may be determined based on experience or practical requirements (e.g., localization accuracy requirements, calculational power requirements, etc.). For example, the higher the localization accuracy required, the greater the preset pixel dimension of the each texture template, and the greater the preset count of texture feature points in the each texture template. As another example, the more limited the calculational power, the fewer the preset count of texture feature points in the each texture template, and the greater the preset pixel size of the each texture feature point.

In some embodiments, the processing device 110 may determine a count of combinations using a combination number formula based on the preset pixel dimension of the each texture template, the preset count of texture feature points in the each texture template, and the preset pixel size of the each texture feature point. The count of combinations refers to a count of texture codes, denoted as H, H>2. The preset pixel size of the each texture template is denoted as M*N (both M and N are the counts of pixel points). For example, a size of each texture image is M*N, and M and N are integers greater than 1. The preset count of texture feature points in the each texture template is denoted as K. For example, each texture template is limited to K texture feature points, and K is an integer greater than 1. The preset pixel size of the each texture feature point is denoted as S. For example, each preset texture feature point occupies a pixel grid size of S, and S is an integer greater than or equal to 1. Then the combination number formula maybe as shown in equation (1) below:

$$H = \frac{C ( M * N , K )}{S} \qquad ( 1 )$$

In some embodiments, the processing device 110 may determine the count of texture templates in the texture code library based on a count of combinations. For example, the processing device 110 may determine, from H texture codes, Num (H>Num) texture codes as texture templates and store the texture templates in the texture code library. As another example, the processing device 110 may store H texture codes as texture templates in the texture code library. Since a finalized count of texture templates in the texture code library is actually determined based on actual requirements, the greater the count of texture templates, the slower the decoding process is, but the greater the decoding accuracy is; in contrast, the less the count of texture templates, the faster the decoding process, but the less the decoding accuracy is. By determining the count of texture templates in the texture library according to the actual requirements, a scale of the texture code library may be flexibly controlled to adapt to different needs, and the adaptability and flexibility of the texture code library can be improved.

As an example only, assuming that the preset pixel dimension of the each texture template is M=800, N=600, the preset count of texture feature points of the each texture template is K=800, and the preset pixel size of the each texture feature point is S=1, then H=C(480000,800). For a DM QR code with an image size of 800*800, assuming that a pixel side of its grid is 100 pixels long, and its encoding format is 7*7, i.e., there are at most 249 code values, and redundancy reservations for rotation and defacement is needed, so a size of a real code library is much smaller than 249. The texture code library based on the texture code is much larger compared to a current 2D code library, which can be adapted to many application scenarios, and also can ensure the uniqueness and accuracy of code values in a coding and decoding process, which greatly reduces the probability of misidentification and improves the robustness and success rate of localization.

Step 520, a feature parameter of the each texture feature point is obtained by randomly encoding the each texture feature point of the each texture template in the texture code library.

The feature parameter of the texture feature point is information that uniquely characterizes the texture feature point, and may include information that indicates a position of the texture feature point in a texture code. The feature parameter of the texture feature point may include a radius of the texture feature point and coordinates of the texture feature point, or the like. When the preset pixel size of the texture feature point is greater than 1, the coordinates of the texture feature point may be the coordinates of the center point of the texture feature point. When the preset pixel size of the texture feature point is equal to 1, the coordinates of the texture feature point are coordinates of the pixel point. In some embodiments, the processing device 110 may randomly encode the each texture feature point of the each texture template in the texture code library to obtain the feature parameter of the each texture feature point.

In some embodiments, the processing device 110 may determine a radius of the each texture feature point of the each texture template based on a preset interval value and a random function. The preset interval value may be set based on experience or demand. For example, the preset interval value may be between 1 and 3. The radius of the each texture feature point of the each texture template may be shown in equation (2) below:

$${r}_{i} = rand ( ) \% ( 3 ) + 1. \qquad ( 2 )$$

where, i denotes a serial number of the texture feature point. rᵢ denotes a radius of an i-th texture feature point, and a value of rᵢ is between the preset interval value. For example, the value of rᵢ may be between 1 and 3. rand( ) denotes the random function for random numbers.

In some embodiments, the processing device 110 may determine the coordinates of the each texture feature point of the each texture template based on the preset pixel dimension of the each texture template and the random function. The coordinates of the each texture feature point of the each texture template may be shown in equation (3) and equation (4) below:

$${u}_{i} = rand ( ) \% ( M - 1 ) . \qquad ( 3 )$$

$${v}_{i} = rand ( ) \% ( N - 1 ) . \qquad ( 4 )$$

where i and rand( ) denote the same meaning as i and rand( ) in equation (2). (uᵢ, vᵢ) denotes coordinates of the i-th texture feature point and M*N denotes the preset pixel dimension of the texture template. The coordinates of the i-th texture feature point may be located at any position in the texture template with the preset pixel dimension of M*N. For example, uᵢ takes a value between 0~(M−1), with M>1; vᵢ takes a value between 0~(N−1), with N>1. Since the generation of uᵢ and vᵢ is based on the random function, the values of uᵢ and vᵢ conform to a random rule.

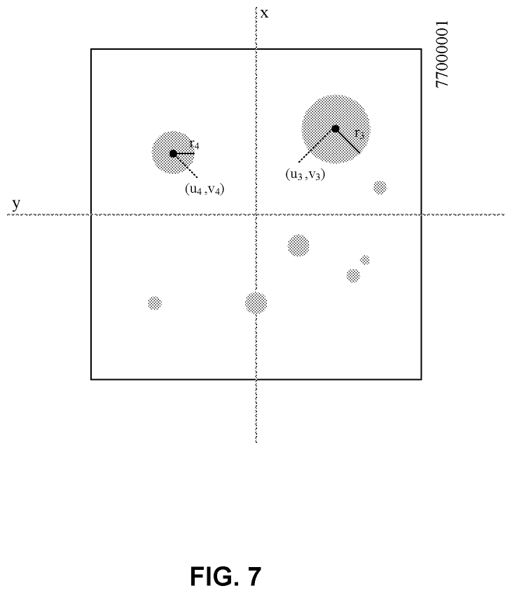

FIG. 7 is a schematic diagram illustrating an exemplary texture template according to some embodiments of the present disclosure. A radius of a texture feature point and coordinates of the texture feature point are illustrated in FIG. 7 as an example. A texture template and texture feature points randomly distributed on the texture template are as shown in FIG. 7. Texture feature points on the texture template are dots with a radius of 1 to 3 pixel grid sizes, including a texture feature point with a radius r3 and a texture feature point with a radius r4. Coordinates of a center point of each texture feature point are coordinates of the each texture feature point. For example, coordinates of the texture feature point with a radius r3 are (u3, v3) and coordinates of a center point of the texture feature point with a radius r4 are (u4, v4). It should be noted that coordinate axes in the texture template are not shown in an actual texture image, and an x-axis and y-axis in FIG. 7 are only for reference.

In some embodiments of the present disclosure, by adopting a randomized coding design using discrete texture feature points, the visual wayfinding features are transformed from the block distribution of a QR code into a discrete point distribution. This change streamlines and refines the visual wayfinding features from a visual perspective while simultaneously allowing for precise determination of the texture code library. By referring to the comparison between a texture code in FIG. 8A and a QR code in FIG. 8B, it can be seen that the texture code can ensure the integrity of a ground, and the impact of the texture code on the appearance of the ground is much smaller than the impact of the QR code on the ground.

Step 530, a template ID is assigned to the each texture template.

In some embodiments, the processing device 110 may generate a template ID for the each texture template. The template ID of the each texture template is unique so as to uniquely identify the texture template. The template ID may include any combination of numbers, letters, characters, etc. For example, a texture template in FIG. 7 has a template ID of “77000001”. The processing device 110 may sequentially assign the template ID in an order in which texture templates were generated.

Step 540, the template ID of the each texture template and the feature parameter of the each texture feature point are stored in the texture code library.

In some embodiments, the processing device 110 may save the template ID of the each texture template generated at the step 530, and the feature parameter of the each texture feature point obtained at the step 520 in the texture code library.

In some embodiments, the texture code library may be pre-generated or newly generated. When the texture code library is not pre-generated, the processing device 110 may save each texture template, the template ID of the each texture template generated at the step 530, and the feature parameter of the each texture feature point obtained at the step 520 to a data storage structure (e.g., a database, etc.) to obtain a newly-generated texture code library. When the texture code library already exists (e.g., pre-generated and stored in a storage device), the processing device 110 may add each texture template, the template ID of the each texture template generated at the step 530, and the feature parameter of the each texture feature point obtained at the step 520 added to the existing texture code library.

As an example only, information in the texture code library may be shown as a data structure shown in Table 1.

TABLE 1

| ID (4 bytes) | r (1 byte) | u (2 bytes) | v (2 bytes) |
|---|---|---|---|
| ID1 | r₁ | u₁ | v₁ |
| ID1 | r₂ | u₂ | v₂ |
| . . . | . . . | . . . | . . . |
| ID1 | rₖ | uₖ | vₖ |
| ID2 | r₁ | u₁ | v₁ |
| ID2 | r₂ | u₂ | v₂ |
| . . . | . . . | . . . | . . . |

ID in Table 1 denotes the template ID, r denotes the radius of the texture feature point, u and v denote the coordinates of the texture feature point, and content of the parentheses denotes a size of a storage space occupied by each parameter.

The storage memory required for the each texture feature point in the texture code library may be small. For example, as shown in Table 1, the texture template ID may take up 4 bytes in length, the radius of the texture feature point may take up 1 byte in length, and the coordinates of the texture feature point, u and v, may take up 2 bytes in length, respectively. So, each texture feature point occupies only 9 bytes of storage space. Assuming that each texture template has 800 texture feature points, a storage space occupied by the each texture template is around 7.2 KB, and for a texture code library containing 10,000 texture templates, a total size of the texture code library is about 72 MB, and after compression, the size is about 50 MB. So, although the texture code library is large, it does not take up much memory, and the texture code library is sufficient for most scenarios.

In some embodiments of the present disclosure, encoding and generating an ultra-large-scale texture code library is realized by generating a texture code library in a completely random manner, which reduces the probability of misrecognition in a decoding process.

The operations of the illustrated processes 300, 400, and 500 presented above are intended to be illustrative. In some embodiments, a process may be accomplished with one or more additional operations not described, and/or without one or more of the operations discussed. Additionally, the order in which the operations of a process described above is not intended to be limiting.

Having thus described the basic concepts, it may be rather apparent to those skilled in the art that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” may mean that a particular feature, structure or characteristic described in connection with the embodiment is included in at least one embodiment of the present disclosure. Therefore, it is emphasized and should be appreciated that two or more references to “an embodiment” “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.), or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A computer-readable signal medium may include a propagated data signal with computer-readable program code embodied therein, for example, in baseband or as part of carrier wave. Such a propagated signal may take any of a variety of forms, including electro-magnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±1%, ±5%, ±10%, or ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present disclosure, or any of same that may have a limiting effect as to the broadest scope of the claims now or later associated with the present disclosure. By way of example, should there be any inconsistency or conflict between the description, definition, and/or the use of a term associated with any of the incorporated material and that associated with the present disclosure, the description, definition, and/or the use of the term in the present disclosure shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method for locating a mobile device, wherein the method is performed by a processing device comprising a memory and a processor, the method comprising:
obtaining a texture image acquired by a mobile device;
determining a target texture template from a texture code library based on the texture image;
determining a matched texture pair count based on the texture image and the target texture template; and
in response to determining that the matched texture pair count is greater than a match threshold, determining a posture of the mobile device based on the matched texture pair count.

2. The method of claim 1, further comprising:
in response to determining that the matched texture pair count is not greater than the match threshold, determining whether the matched texture pair count is greater than a pose threshold, the pose threshold being less than the match threshold; and
in response to determining that the matched texture pair count is greater than the pose threshold, determining the posture of the mobile device based on the matched texture pair count.

3. The method of claim 2, further comprising:
in response to determining that the matched texture pair count is greater than the pose threshold, generating a warning that the texture image is obscured or defaced.

4. The method of claim 2, further comprising:
in response to determining that the matched texture pair count is not greater than the pose threshold, outputting a localization failure signal.

5. The method of claim 1, wherein the match threshold is correlated with localization accuracy.

6. The method of claim 1, further comprising:
determining whether a preset image ID is obtained; and
in response to determining that the preset image ID is obtained, determining the target texture template from the texture code library based on the texture image and the preset image ID.

7. The method of claim 6, further comprising:
in response to determining that the preset image ID is not obtained, determining the target texture template by searching the texture code library.

8. The method of claim 1, wherein the texture code library is obtained by:
determining a count of texture templates in the texture code library;
obtaining a feature parameter of each texture feature point by randomly encoding each texture feature point of each texture template in the texture code library;
assigning a template ID to the each texture template; and
storing the template ID of the each texture template and the feature parameter of the each texture feature point in the texture code library.

9. The method of claim 8, wherein the feature parameter of the each texture feature point includes a radius and coordinates of the each texture feature point.

10. The method of claim 9, wherein the obtaining the feature parameter of the each texture feature point by randomly encoding the each texture feature point of the each texture template in the texture code library includes:
determining a radius of the each texture feature point of the each texture template based on a preset interval value and a random function; and
determining coordinates of the each texture feature point of the each texture template based on a preset pixel dimension of the each texture template and the random function.

11. The method of claim 8, wherein the determining the count of texture templates in the texture code library includes:
determining the count of texture templates in the texture code library based on a preset pixel dimension of the each texture template, a preset count of texture feature points of the each texture template, and a preset pixel size of the each texture feature point.

12. The method of claim 11, wherein the determining the count of texture templates in the texture code library based on the preset pixel dimension of the each texture template, the preset count of texture feature points of the each texture template, and the preset pixel size of the each texture feature point includes:
determining a count of combinations using a combination number formula based on the preset pixel dimension of each texture template, the preset count of texture feature points of each texture template, and the preset pixel size of each texture feature point; and
determining the count of texture templates in the texture code library based on the count of combinations.

13. A method for establishing a texture code library for locating a mobile device, wherein the method is performed by a processing device comprising a memory and a processor, comprising:
determining a count of texture templates in a texture code library;
obtaining a feature parameter of each texture feature point by randomly encoding each texture feature point of each texture template in the texture code library;
assigning a template ID to the each texture template; and
storing the template ID of the each texture template and the feature parameter of the each texture feature point in the texture code library.

14. A system for locating a mobile device, wherein the system comprises a memory and a processor, the memory stores computer instructions, and when executing the computer instructions, the processor is configured to perform operations comprising:
obtaining a texture image acquired by a mobile device;
determining a target texture template from a texture code library based on the texture image;
determining a matched texture pair count based on the texture image and the target texture template;
in response to determining that the matched texture pair count is greater than a match threshold, determining a posture of the mobile device based on the matched texture pair count.

15. The system of claim 14, wherein the processor is further configured to perform operations comprising:
in response to determining that the matched texture pair count is not greater than the match threshold, determining whether the matched texture pair count is greater than a pose threshold, the pose threshold being less than the match threshold; and
in response to determining that the matched texture pair count is greater than the pose threshold, determining the posture of the mobile device based on the matched texture pair count.

16. The system of claim 15, wherein the processor is further configured to perform operations comprising:
in response to determining that the matched texture pair count is greater than the pose threshold, generating a warning that the texture image is obscured or defaced.

17. The system of claim 15, wherein the processor is further configured to perform operations comprising:
in response to determining that the matched texture pair count is not greater than the pose threshold, outputting a localization failure signal.

18. The system of claim 14, wherein the match threshold is correlated with localization accuracy.

19. The system of claim 14, wherein the processor is further configured to perform operations comprising:
determining whether a preset image ID is obtained; and
in response to determining that the preset image ID is obtained, determining the target texture template from the texture code library based on the texture image and the preset image ID.

20. The system of claim 19, wherein the processor is further configured to perform operations comprising:
in response to determining that the preset image ID is not obtained, determining the target texture template by searching the texture code library.

21-27. (canceled)
